(19) United States
(12) Patent Application Publication
(10) Pub. No.: US 2009/0145855 A1
(43) Pub. Date: Jun. 11, 2009

(54) Water Purifier System and Method

(75) Inventors: Edwin David Day, Calgary (CA); Robert Brian Knight, Calgary (CA); John Douglas Pink, Calgary (CA)

Correspondence Address: NOVAPURE SYSTEMS, INC., BAY 6, 3530 - 11A STREET NE, CALGARY, AB, T2E-6M7, CA

(73) Assignee: Novapure Systems Inc., Calgary (CA)

(21) Appl. No.: 11/951,520

(22) Filed: Dec. 6, 2007

(51) Int. Cl. C02F 1/32

(52) U.S. Cl. 210/748; 250/436

(57) ABSTRACT

The invention provides a water purification system and method for combining ultraviolet germicidal irradiation and photocatalysis in a helical reactor geometry that maximizes both the photocatalytic efficiency and the germicidal dosage of the ultraviolet irradiation in deactivation of microbes and the destruction of contaminant organic compounds.

### CROSS-REFERENCE TO RELATED APPLICATIONS

U.S. patent application Ser. No. 11,835,899

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to a system and method for purifying water containing organic compounds, certain inorganic compounds, and microbial contaminants by combining filtration, ultraviolet germicidal irradiation, and photocatalysis in a helical reactor geometry that maximizes (a) photocatalyst surface illumination by UV photons, and (b) contaminant/photocatalyst contact, as well as, (c) providing a quantitative basis for estimating the efficacy of the assembly.

Some of the earliest published references to titania (titanium dioxide or TiO₂) photocatalysts are by Formenti, M., et al., “Heterogeneous Photocatalysis for Oxidation of Paraffins”, Chemical Technology 1, 680-686, 1971 and U.S. Pat. No. 3,781,194 issued Dec. 25, 1973. Since the 1972 discovery, by Fujishima and Honda, of the photocatalytic splitting of water on titanium dioxide electrodes, the science and technology related to heterogeneous photocatalysis in both water and air has been extensively studied and is the subject of numerous patents and scientific publications. Both the physics and chemistry of heterogeneous photocatalysis remain areas of active investigation. Much of the early work of relevance to this patent is summarized in Reference 1, by Okura, et al., including extensive discussion of the self-cleaning properties of irradiated photocatalytic surfaces. Despite investigation of many alternatives, the anatase crystal morphology of titanium dioxide remains the photocatalytically active semi-conductor of economic choice, although many claims of additive enhancements have been and continue to be made. Other, possibly less economic, photocatalytic materials continue to be discovered and investigated, as exemplified by Reference 2.

Not all water contaminants are treatable by filtration and photocatalysis. Dissolved inorganic salts, in particular, require other chemical and/or physical demineralization processes, e.g., reverse osmosis.

Photocatalytic water purifier design considerations, impacting performance, include: (a) the intensity and wavelength of irradiation at the illuminated photocatalyst surface, (b) the magnitude of the illuminated photocatalyst surface area, (c) the rate of flow of contaminants past the illuminated photocatalyst surface area, (d) intimate contact of contaminants with the illuminated photocatalyst surface, and (e) the self-cleaning properties of the water/contaminant contacted photocatalyst surface. The “quantum or photocatalytic efficiency” relates to the fraction of light-source photons that are effective in causing photocatalyzed reactions. Considerable effort is currently being expended, in the field of heterogeneous photocatalysis, to enhance the photocatalytic efficiency of anatase titanium dioxide with various catalytic additives (as described in many of the patents cited, e.g., U.S. Pat. Nos. 6,409,928, 6,179,972, and 6,221,259) and to extend the wavelength of photocatalyst-activating irradiation into the visible wavelength range, as described in U.S. Pat. Nos. 7,153,808 and 7,175,911.

Published designs of photocatalytic reactors for water purification include both unconsolidated/dispersed and immobilized photocatalyst materials:
1. photocatalyst slurry reactors (dispersed photocatalyst particles)
2. fluidized photocatalyst bed reactors (photocatalyst immobilized on substrate particles, beads, or balls)
3. packed bed reactors (photocatalyst immobilized on substrate packing surfaces; honeycombs may be deemed to be a form of “packed bed”)
4. tubular reactors (annular or helical geometry, immobilized surface coatings, including the present patent)
5. catalyst-coated rotating-tube-bundle reactors

Since photocatalyst illumination is the most important factor, in photocatalytic water purification, access to the photocatalyst surface by photons is critical. In all reactor types, water turbidity should be minimized by pre-filtration. In reactor types 1-3, light penetration depth is impeded by photocatalyst particle light absorption/shadowing and Beer-Lambert absorption. Without induced turbulence, reactors of type 4 (other than the present invention) are most limited by (a) Beer-Lambert absorption, (b) relatively small illuminated photocatalyst surface area, and (c) limited contact between contaminants and illuminated photocatalyst surface. Reactor type 5 overcomes many of the problems of reactor types 1-4, but with considerable complexity (many fast moving parts). Reference 6 verifies the importance of turbulence in achieving contaminant/photocatalyst contact (reactor type 5).

As discussed below, the prior art includes many water purification systems and methods involving UV light sources and either helical/spiral wound tubing or baffles or guides within the apparati that cause the water stream to spiral about the UV light source. None of the prior art apparati containing helical/spiral tubes have such tubes internally coated with photocatalyst. Without a photocatalytic coating, otherwise transparent tubing walls and windows, in contact with water to be treated, can become fouled (sliming and/or sedimentation), requiring elaborate cleaning mechanisms or processes. Some prior art water purification reactor systems and processes require elevated temperatures and other non-photocatalysts that are not relevant to the current patent.

A further consideration in the design of an ambient-temperature photocatalytic water purification reactor is the wavelength of the photocatalyst-activating radiation. There is some evidence (Reference 4) that more energetic photons (254 nm) are more effective in photocatalyzing water-borne contaminants than less energetic photons (365 nm). The photon energy in excess of the band-gap energy of the photocatalyst would be expected to add to the kinetic energy of the released electrons and, thereby, contribute to the activation energy of reaction intermediates (i.e., promote reactions). Enhanced photocatalytic activity is in addition to the germicidal benefit of direct ultraviolet germicidal irradiation alone.

Where the photocatalyst substrate (tubing) material is optically transparent, the tubing wall acts as an elementary waveguide having a reactive inner coated surface. Refraction and reflection (both internal and external) ensure efficient distribution of light photons throughout the length of the helix, until absorption at the internal photocatalytic coating occurs.

Early work with photocatalyst powder coatings encountered particle size minimization and bond-to-substrate issues. Unconsolidated powder slurries present photocatalyst recovery and recycling problems. Various high temperature coating application techniques have been technically successful but are economically and practically prohibitive for coating the interior surfaces of tubing. Organic binders for powders, such as methylmethacrylate and various organic resins, can not be expected to provide sufficient bond strength to withstand the erosion of fast-flowing water. Titanium oxide films formed by baked inorganic peroxotitanium hydrate sol gels together with a peroxotitanic acid binder have been found to have good substrate-bonding and photocatalytic properties.

Photocatalyzed reactions of organic compounds are known to be strongly endothermic, such that the photocatalyst-activating energy output of commonly available lamps limits the concentrations of treatable water-borne contaminants to parts-per-million (ppm) or less. The concentrations of most organic water-borne contaminants and pathogens are within this treatable range. However, cycling of contaminated water through a photocatalytic water reactor would progressively reduce higher concentrations of contaminants.

U.S. Pat. No. 4,798,702 discloses a sterilizer unit for fluid media and process. The sterilizer contains a length of thin-walled corrugated tubing/pipe in the shape of a helix coiled around a germicidal radiation source. The tubing is formed from tough, flexible fluorinated polyalkylene resin which is transparent and resistant to germicidal UV irradiation and is also resistant to buildup of film on the inner surface. No photocatalysis is claimed.

U.S. Pat. No. 4,956,754 discloses an ultraviolet lamp assembly, including a helical tubing coil enclosing a high intensity germicidal ultraviolet lamp (140 to 390 nm), as in the present invention. A tubular housing is preferably of a highly reflective material, as in the present invention. No photocatalysis is claimed.

U.S. Pat. No. 5,004,541 discloses an ultraviolet radiation fluid purification system involving both filtration and transparent conduits (tubing) helically wound closely about the UV light. The system exposes the fluid to UV irradiation both before and after filtration (a double helix). This is a bidirectional flow helix; water in adjacent coils flows in opposite directions. It should be noted that a unidirectional coil, of the same length achieves the same UV dosage (same passage over the UV source lamp). The latter patent adds reverse osmosis and deionization units to the treatment process. No photocatalysis is claimed.

U.S. Pat. No. 5,069,782 discloses fluid purification systems consisting of a unitary housing, longitudinal UV lamp (wavelength of output undisclosed), a pair of helical UV-transparent plastic coils surrounding the lamp, and a longitudinal filter, arranged such that water is exposed to UV energy before and after filtration. The helical coils and UV lamp/bulb are enclosed in a reflective sleeve. The housing is not reflective. No photocatalysis is claimed.

U.S. Pat. No. 5,069,985 discloses a photocatalytic fluid purification apparatus having helical nontransparent substrate surfaces. Within an annular cylindrical housing, one or more nontransparent photocatalyst-coated substrates are coiled longitudinally and helically around a transparent sleeve enclosing the light source of an “activating wavelength”. Water flow is directed to spiral turbulently about the light source. Beer-Lambert absorption would be expected to reduce illumination of the outer portions of the substrate helix.

U.S. Pat. No. 5,230,792 discloses an ultraviolet water purification system with variable intensity control such that the UV lamp output intensity is matched to the fluid flow. While not part of the claims, FIG. 1 of the patent shows bidirectional helical coils (of some UV impervious material) surrounding the UV light source (bulb). No photocatalysis is claimed.

U.S. Pat. No. 5,266,215 discloses a water purification unit which combines germicidal UV irradiation and carbon filtration plus UV irradiation in two sections along the same linear UV light source enclosed in a sleeve. The water to be purified is made to swirl about the source of UV radiation in the first section. An ozone generator is suggested to enhance the biocidal process. UV wavelength is not disclosed.

U.S. Pat. No. 5,376,281 discloses a water purification system and apparatus that includes a plurality of UV radiators comprised of four sets of water-conducting helical quartz tubes surrounding each UV light source, as well as, a plurality of filtration stages including fine, ultrafine, and micro-filters. A first UV radiator/reactor contains a bed of coarse quartz granules followed by a bed of noble metal. A second UV radiator/reactor contains a bed of noble metal followed by a bed of coarse quartz granules. A third radiator/reactor contains a bed of noble metal followed by a bed of coarse quartz granules. A fourth radiator/reactor contains a bed of coarse quartz granules. Vibration of the quartz granules and exposure to noble metals is stated to destroy microbes. No photocatalysis is claimed.

U.S. Pat. No. 5,384,032 discloses a water purifying and sterilizing apparatus which includes a box (enclosure) containing three filtering chambers: the first containing resin, the second containing charcoal, and the third containing a UV lamp. Internal baffles cause the water to circulate spirally around the UV lamp. No photocatalysis is claimed.

U.S. Pat. No. 5,393,419 discloses an ultraviolet lamp assembly for water purification. The apparatus described consists of a cylindrical pressure vessel housing a UV light. The UV lamp assembly is sealed within a transparent sleeve. Internal deflectors and baffles regulate the water flow rate and cause the water to circulate in a helical pattern around the UV lamp. There is an allusion to a filter stage. No photocatalysis is claimed.

U.S. Pat. No. 5,597,487 discloses an annular water purification system and apparatus comprised of a housing, elongate/linear UV lamp, a sleeve/tube isolating the lamp from the water, and a reflective surface in the annular flow path to UV rays back through the water. No photocatalysis is claimed.

U.S. Pat. No. 5,785,845 discloses a water purifying system using hydrogen peroxide and/or ozone to enhance the germicidal efficacy of the UV lighting system. A plurality of baffle ridges and grooves produce a rifled spiraling configuration to disrupt laminar flow of contaminated water and bring it in close proximity to the UV source. No photocatalysis is claimed.

U.S. Pat. No. 5,874,741 discloses an apparatus for germicidal cleansing of water having an ellipsoid chamber containing UV lamps or lasers along the major axis of the ellipsoid. Openings at the ends of the ellipsoid provide entry and exit points for the water. The internal surface of the chamber is formed from a UV-reflective material. A UV-transparent water conduit (tubing) has a helical configuration which spirals about the UV light source through the chamber. No photocatalysis is claimed.

U.S. Pat. No. 6,153,105 discloses an ice-maker treatment system that disinfects water in an ice-making machine. The system includes at least one UV-transparent tube wound into an approximately spiral shape (helix) and with a UV lamp placed approximately into a center of the spiral shape. No photocatalysis is claimed.

U.S. Pat. No. 6,162,406 discloses an electrodeless discharge system for ultraviolet water purification consisting of a housing, electronic control circuitry, a low pressure electrodeless discharge lamp with a toroidal discharge, and UV-transparent tubing wrapped in one or more turns around the lamp (helix). No photocatalysis is claimed.

U.S. Pat. No. 6,379,811 discloses the method of preparation of a yellow transparent jelly (viscous) amorphous type titanium peroxide sol which serves as an excellent binder for titanium dioxide powders and sol gels. These patents further teach that when the titanium peroxide sol is heated at 100 degrees C or more for several hours, the anatase type of titanium oxide sol is obtained. When a substrate is coated with the amorphous type titanium peroxide sol and then dried and heated at 250 to 940 degrees C., an anatase type of titanium dioxide is obtained. This material is similar to the preferred material used to coat the substrate tubing of the present invention,

U.S. Pat. No. 6,531,035 discloses several apparati and methods for low and high flux photocatalytic pollution control in air and water. This patent provides an interesting classification of catalytic media arrangements into six types. The low-flux photocatalytic media of this invention (operating at temperatures less than 100 deg. C.) are biopolymers such as cotton fabric or flannel cloth supporting titania “molecules” in a photocatalytic “stocking”. The high-flux photocatalytic media of this invention (operating at temperatures in the range 150-400 deg. C.) are support materials like silica, alumina, zeolites, zeolite-like materials, and synthetic aerogel materials, all doped or coated with photo- and thermocatalyst).

U.S. Pat. No. 6,558,639 discloses an apparatus and method for purifying fluids including contaminants, primarily focused upon air, but mentions washing water in a fifth embodiment. The central concept of the apparatus is a bundle of bundles of linear tubes (pipes) through which the fluids are directed. The inner surfaces of the outer tubes and both inner and outer surfaces of the inner tubes are coated with photocatalyst. The walls of all tubes are transparent to UV irradiation from one or more external lamps oriented in parallel with the tube bundles and fluid flow. Groupings of bundles are also claimed to be possible in series, parallel, or arranged in oblique angles to the direction of fluid passage. There is no discussion of either attenuation of UV intensity at the inner-most tubes or mass transfer/mixing for contaminant-photocatalyst contact. Coating of the tubes is similar to that of the present invention.

U.S. Pat. No. 6,685,825 discloses a water treatment system combining ozone injection and monitoring apparatus in which the ozone/water mixture is propelled upward in a spiral circling around the quartz sleeve of the UV lamp of the sterilizing unit. There are no claims for photocatalysis.

U.S. Pat. No. 6,700,128 discloses an apparatus and method for simultaneously germicidally cleansing both air and water involving a germicidal UV chamber in the form of one or more ellipsoid sections. The UV lamp is in the form of a helix around the center line of the chamber. The pitch of the helix may vary along its length so as to concentrate the UV radiation towards the center of the chamber. A transparent conduit for liquids may be positioned in the center of the coils of the UV lamp. This is the reverse geometry to the present invention. There are no claims for photocatalysis.

U.S. Pat. No. 6,752,971 discloses an ultraviolet water disinfection reactor (flanged insert) for installing in an existing water pipeline. The reactor consists of a plurality of UV lamps within quartz sleeves arranged (in the reactor segment) transversely to the pipeline flow. UV power intensity can be expected to be intense in the immediate vicinity of the lamps, however, flow rate and Beer-Lambert absorption tend to diminish the effective dosage. There are no claims of photocatalysis.

U.S. Pat. No. 6,875,988 discloses a germicidal lamp and purification system having turbulent flow. A helical grooved contour may be placed directly on the tubular envelope of the UV lamp or on the transparent sleeve enclosing the UV lamp. Such a contour creates turbulence when placed in a fluid flow. The turbulence improves the germicidal efficiency of the UV irradiation. There are no claims of photocatalysis.

U.S. Pat. No. 6,902,653 discloses an apparatus and method for photocatalytic purification and disinfection of fluids directed through a semitransparent packed bed or an open-cell, three-dimensionally reticulated, fluid permeable, semiconductor (substrate, photocatalyst, and co-catalysts) unit irradiated by UV light in the wavelength range 340-390 nm.

U.S. Pat. No. 6,932,903 discloses an ultraviolet-and-ozone disinfection apparatus having improvement on disinfection effect. The apparatus includes a ozone generating UV lamp within a quartz sleeve with the annulus filled with air such that ozone is generated in the annulus. The ozone is drawn into the water stream by a venturi. The combined ozone/water stream then circulates around the quartz sleeve through a UV-transparent tubing coil (helix). There are no claims of photocatalysis.

U.S. Pat. No. 6,932,947 discloses a fluid purification and disinfection device, which includes a housing, UV lamp, and a photocatalytic surface consisting of either a spiral-shaped metal plate or a metal mesh coated on both sides with titanium dioxide and installed around the UV lamp.

U.S. Pat. No. 6,946,651 discloses a method and apparatus for water purification that involves a tubing coil (helix) enclosing one or more UV lamps, as in the present invention. However, There are no claims of photocatalysis.

U.S. Pat. No. 7,008,473 discloses a system and process for photocatalytic treatment of contaminated air involving an aqueous phase. The system is primarily targeted towards decontaminating air streams (gas scrubber tower) using an aqueous photocatalytic slurry. Details of UV wavelength and photocatalyst surface illumination effectiveness are not provided.

U.S. Pat. No. 7,230,255 discloses an annular photocatalytic sterilizer in which water is directed through an annulus containing a photocatalyst-coated “carrier” that is illuminated by a UV lamp (wavelength undisclosed) from the inside. The photocatalyst carrier comprises a spherical, cylindrical, spring-shaped or tube-shaped net made of silica gel, silica, alumina, zeolite, stainless steel, copper, nickel, silver, aluminum, and silver-plated metals.

U.S. Pat. App. No. 20050016907 discloses a electro-optical water sterilizer that directs the water stream in a spiral course (“spiral pipeline”) about a quartz sleeve (“bushing”) enclosing a germicidal UV light source (253.7 nm). The word “spiral” describes the flow pattern of the water and not a tubular helix. The germicidal effect of this sterilizer is very similar to the present invention. No photocatalysis is claimed in this application.

U.S. Pat. App. No. 20060019104 discloses a process for the production of a photocatalytically active coated glass. This application also presents the coating durability results of standard abrasion and humidity cycling tests. Thin coats were found to have good durability.

U.S. Pat. App. No. 20060231470 discloses a photocatalytic water treatment apparatus comprised of a plurality of pairs of stacked, photocatalyst-coated disks and supports which form a cylindrical cartridge with a cylindrical open interior in which a linear UV light source is positioned. The UV light source is a tubular element extending the length of the treatment cartridge. Each disk has a pattern of alternating concentric ribs and grooves that complement the pattern on the opposing disk face to define a flow chamber having a series of concentric flow channels (labyrinthine), such that the water to be treated follows a tortuous path and contacts the full length of each flow channel. The disks are claimed to be made of transparent UV-resistant polymethylmethacrylate plastic, which suggests that the UV wavelength is not germicidal, since such plastic is neither transparent nor resistant to germicidal ultraviolet radiation. There is no discussion of turbulent flow (mass transfer), although that is to be expected from the flow channel configuration.

U.S. Pat. App. No. 20070020158 discloses a photocatalyst water treating apparatus combining a filtration unit, a photocatalytic processing unit, and an electrolysis unit for removing inorganic and organic contaminants from water without using chemicals. The UV light source can emit radiation ranging from 180 to 400 nm. The UV lamps and planar photocatalytic elements are arranged such that the lamps irradiate both sides of each photocatalytic element.

U.S. Pat. App. No. 20070095647 discloses a method and apparatus for producing reactive oxidizing species via photocatalytic reactions under UV light (in the wavelength ranges 182-187 nm and 250-255 nm) in humid air. The patent apparently contemplates using polyvinyl chloride as a binder to fix the photocatalyst powder to a substrate, which is then exposed to the UV light. Such short wavelength UV radiation should be expected to degrade the PVC over time. Although the patent uses the words “water purification”, there is little descriptive detail that would enable a practitioner, skilled in the art, to apply the method or apparatus to water purification.

U.S. Pat. App. No. 20070125713 discloses a water purifier with UV and an adsorbent media list that includes titanium dioxide. The application discusses adsorbent surface modification which includes additional coatings which may be applied to adsorbent media and which may increase the catalytic activity. No specific mention of photocatalysis is made. The application states, “light sources suitable for this invention may radiate in a range from about 200 nm to over 350 nm, preferably in a narrow band around 265 nm”, the lower range of which is germicidal.

U.S. Pat. App. No. 20070245702 discloses porous honeycomb structures and manufacturing methods for use in air and water purifiers. The patent application describes many manufacturing routes with incorporation of fine catalytic metal and photocatalyst particles, as well as photocatalytic test results in both air and water using a 4 W black light source.

WO/2006/043283 discloses an integrated portable water purifier incorporating a UV lamp for microbiological treatment, but without photocatalysis.

WO/2007/010549 discloses a household reverse osmosis based drinking water purifier that incorporates ultra-filtration and/or UV treatment, but without photocatalysis.

WO/2007/026811 discloses a water purification device that floats at the water surface in a containment tank. A photocatalyst-coated, translucent, and water permeable mass illuminated by UV irradiation provides the photocatalytic purification of contacted water. Mass transfer of water to the photocatalyst surface is by “forced convection” by a convection device.

### BRIEF SUMMARY OF THE INVENTION

The principal objective of the present invention is to introduce a helical system reactor geometry that provides efficient water purification by combining (a) filtration, (b) a large, efficiently-illuminated photocatalytic surface area, (c) a short UV light penetration distance (less than or equal to the tubing inside diameter), and (d) intimate surface contact between water/contaminant and the illuminated photocatalyst surface through flow turbulence induced by the curvature of the tubing helix.

Secondary objectives of the present invention are to provide formulae that permit quantified estimation of (a) the ultraviolet germicidal irradiation dosage delivered by the system, (b) the available photocatalyst substrate surface, and (c) the applied photocatalyst coating density (g/cm²) on that substrate surface. The germicidal dosages and photocatalyst coating densities are proxies for the photocatalytic efficacy of the invention, in the absence of simple estimation formulae.

The major elements of the water purification system of the present invention are a filter, motor, pump, and one or more photocatalytic units (arranged in series or parallel), each consisting of an annular arrangement of three components: (a) an internally UV-reflective outer housing that encloses (b) a tubing coil (helix) concentrically/coaxially further enclosing (c) a UV light source illuminating the entire inside area and volume of the helix.

The photocatalyst substrate (tubing) material is UV-transparent such that the tubing wall acts as an elementary waveguide having a reactive inner (coated) surface. Refraction and reflection (both internal and external) ensure efficient distribution of UV light photons throughout the length of the helix, until absorption at the photocatalytic coating occurs. Such optical properties of light conducting materials are discussed, at length, in U.S. Pat. Nos. 5,875,384 and 6,051,194, with respect to fiber optic cable reactors.

### BRIEF DESCRIPTION OF THE DRAWINGS

The various features of the present invention may be more fully understood with reference to the following description and the accompanying drawings in which:

FIG. 1 is a schematic representation of one embodiment of an assembled photocatalytic unit (the photocatalytic reactor), including water flow and the major components of a complete system.

FIG. 2 is a schematic representation of a water purification system illustrating a series combination of photocatalytic units.

FIG. 3 is a schematic representation of a water purification system illustrating a parallel combination of photocatalytic units.

FIG. 4 is the basis for the development of EQUATION 1, adapted for notational reference, from FIG. 3 in U.S. patent application Ser. No. 11,835,899

### DETAILED DESCRIPTION OF THE INVENTION

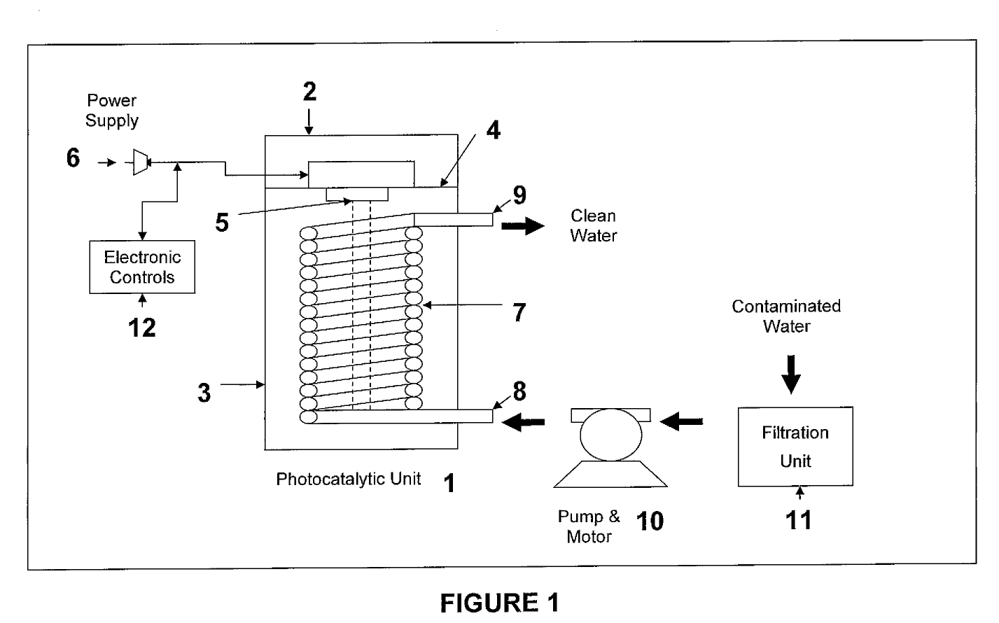

FIG. 1 is an illustrative schematic diagram of one embodiment of a water purifier system and assembly with a photocatalytic unit according to the present invention. The photocatalytic unit, 1, generally includes the housing (top, 2, sides, 3, light source mounting plate, 4, a photocatalyst-activating light source, 5, a light source power supply, 6, a tubing coil (helix), 7, contaminated water inlet connections, 8, clean water outlet connections, 9, water motive means (e.g., gravity or pump and motor), 10, filtration unit, 11, electronic controls, 12, as well as water flow.

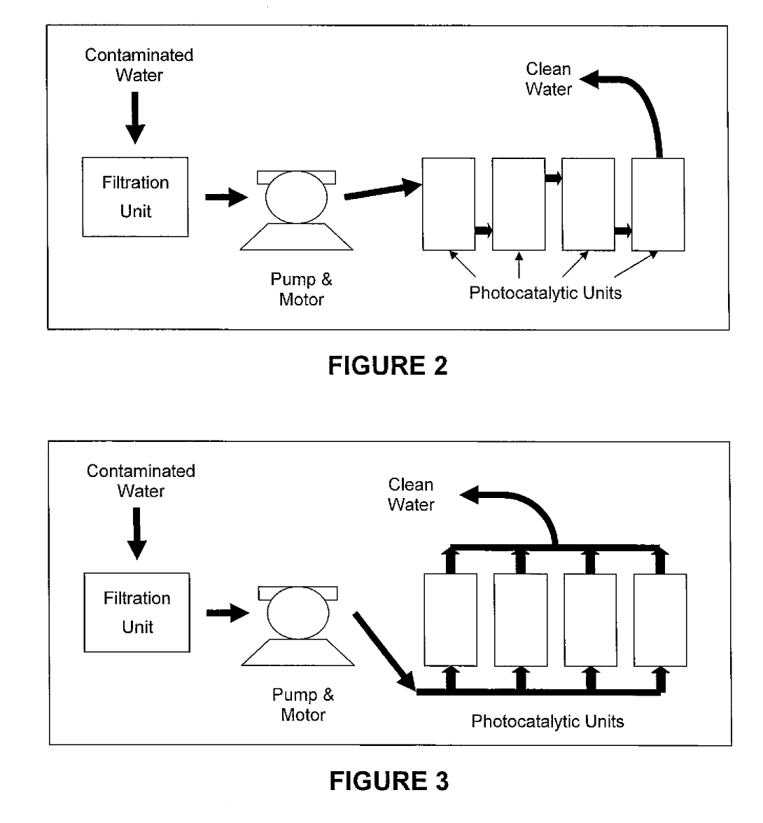

What are not shown in FIG. 1 are the helix stabilizing brackets (within the housing) and details of the water hose/pipe connections, 8 and 9, to the photocatalytic unit. Similarly, details of valves, fittings, controls, and the inter-connections between photocatalytic units are not shown in FIG. 2, as well, details of the inlet (distribution) manifold, outlet (collection) manifold, and associated inter-connections are not shown in FIG. 3.

### Ultraviolet Germicidal Irradiation

To be germicidal, the wavelength of the UV radiation must be sufficiently short (energetic) to break chemical bonds or, at least, denature the DNA or proteins of microbes. This is generally accepted to be in the UV-V and UV-C ranges of the electromagnetic spectrum. While it may not be intuitive, given the quite different geometries, the “average” ultraviolet germicidal irradiation dosage (energy per unit area irradiated) within the photocatalytic unit tubing coil (helix) may be estimated by similar formulae developed for the longitudinal “light-in-pipe” dosage for a steady-state flow of air, as derived in the U.S. patent application Ser. No. 11,835,899, but adjusted for Beer-Lambert absorption in a UV-absorbing medium (water and contents) with an “extinction coefficient, ε. The helix, 7, now substitutes for the pipe, 20, in length and the fluid flow, F (cubic feet per minute or “cfm”), maintains the same definition (except for units changes from air to liquid measures, say to US gallons per minute or “gpm”). The light source, 19, remains on the helix axis. However, the radius, R, of a “hypothetical pipe”, flow-equivalent to the helical tubing coil now requires additional calculation, as well as, the average optical path length, P, for the fluid within the helical tubing coil. Knowledge of both ε and P permit an estimate of how much the UV intensity is diminished by passing through the absorbing fluid to the photocatalyst surface on the far side of the tube.

The average optical path length within the tubing is the average length of all chords defined by rays from any point at the light source intersecting the cross-section circle of the tubing, all in the same plane, where each chord length is defined by:

Chord(θ)=2*sqrt{r²−[r*cos(θ)−sqrt(C²−r²)*sin(θ)]²}, and

where, r=radius of the tubing.
C=length of the ray to the center of the tubing.
θ=the angle between the ray intersecting the tubing and the ray tangent to the tubing, such that θₘₐₓ=arcsin(r/C), which is the angle between the ray tangent to the tubing circle and the ray through the tubing cross-section circle center, defining the domain of θ as 0≦θ≦θₘₐₓ.

Now the average optical path length, P, (of rays intersecting the tubing) is given by

P=[∫Chord(θ)dθ]/θₘₐₓ, integrating between θ=0 and θ=θₘₐₓ.

The average optical path length, in the example below, is 0.7846 cm for a 1.00 cm diameter tubing. The result is not sensitive to the length of rays for C much greater than r. As expected, the average optical path length is less than the diameter of the tubing, i.e., P<2r.

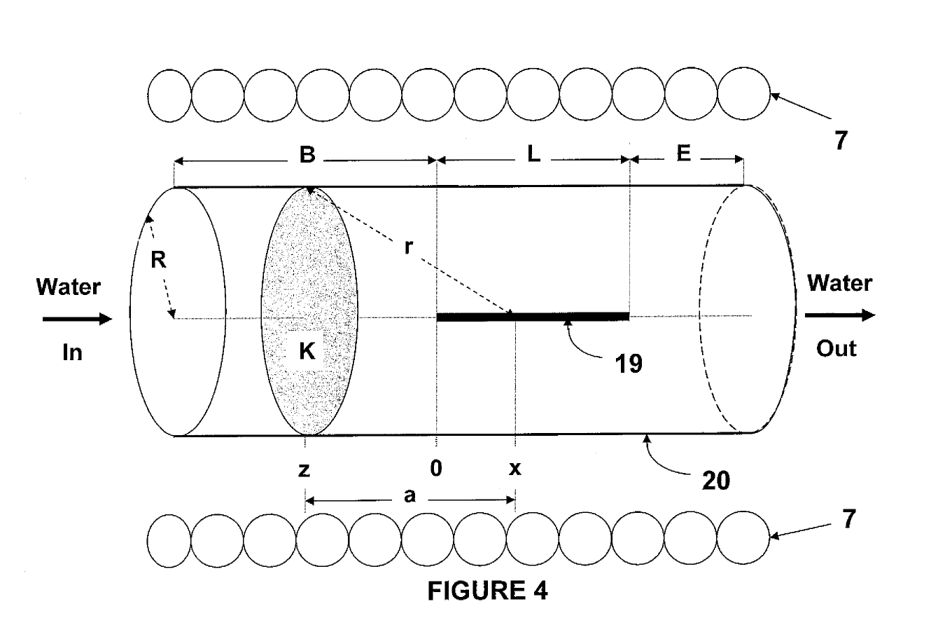

With reference to FIG. 4, if the inlet end of the light source is considered to be at the origin (zero) of the x-axis, then −B (negative B) is the x-coordinate of the inlet end of the helix, L is the x-coordinate of the outlet end of the light source, and L+E defines the x-coordinate of the outlet end of the helix. K is a “hypothetical” photon-accumulating surface moving through the radiation field of the light source at the same linear velocity as the water through the flow-equivalent pipe (not the velocity within the tubing). It is the radius of K, i.e., R, that must be calculated so that the transit time, t, of K through the pipe is the same as the transit time through the helix. The transit time for the water is calculated as the internal volume of the helix, V, divided by the flow rate, F, of the water, i.e., V/F. Therefore, the linear velocity of K, i.e., F/K, is given by the length of the helix/pipe divided by the transit time, (B+L+E)/(V/F) or

F*(B+L+E)/V=F/K, (F divides out from both sides of the equation).

Solving the above equation for K yields

$$K = V / ( B + L + E ) = π {R}^{2} , \\ ( round pipe ) .$$

Therefore,

R=sqrt(V/(π*(B+L+E))

### UV Energy Dosage

Because the volumes of liquid water flow are so much less than the volumes of air flow (1 cfm=7.480519 gpm, US liquid), the residence time of water in the radiation field of a UV light source can be much higher in water than in air, such that the UV energy dosages can be correspondingly higher. If the steady-state water flow rate is F (in cubic feet per minute), the average linear velocity of K is F/K (feet per minute, where K is measured in square feet). The transit time for K to traverse the helix/pipe, i.e., K to travel from −B to L+E along the x-axis, is (B+L+E)*K/F. Therefore, the cumulative UV dosage (watt-sec./cm² or joule/cm²), CD, delivered by the UV light source and received by area K traversing the helix/pipe is the sum of three parts: the two single-sided end contributions, CD_{B} and CD_{E}, and the two-sided (both sides of K) contribution at the bulb, CD_{L}, such that

$${CD}_{o} = {CD}_{B} + {CD}_{L} + {CD}_{E} , \\ before Beer \text{-} Lambert law adjustment \\ and \\ CD = {CD}_{o} {e}^{- ɛ P} , after Beer \text{-} Lambert law adjustment \\ where \\ {CD}_{B} = ( W / ( 2 * F * L ) ) * \{ B * L + 0.5 * ( B * {[ {B}^{2} + {R}^{2} ]}^{1 / 2} + L * {[ {L}^{2} + {R}^{2} ]}^{1 / 2} - ( L + B ) * {[ {( L + B )}^{2} + {R}^{2} ]}^{1 / 2} + {R}^{2} * ln \{ ( R * ( L + {[ {L}^{2} + {R}^{2} ]}^{1 / 2} ) / ( ( {[ {B}^{2} + {R}^{2} ]}^{1 / 2} - B ) * ( L + B + {[ {( L + B )}^{2} + {R}^{2} ]}^{1 / 2} ) ) ) \} ) \\ {CD}_{L} = W * L / F \\ and \\ {CD}_{E} = ( W / ( 2 * F * L ) ) * \{ E * L + 0.5 * ( E * {[ {E}^{2} + {R}^{2} ]}^{1 / 2} + L * {[ {L}^{2} + {R}^{2} ]}^{1 / 2} - ( L + E ) * {[ {( L + E )}^{2} + {R}^{2} ]}^{1 / 2} + {R}^{2} * ln \{ ( R * ( L + {[ {L}^{2} + {R}^{2} ]}^{1 / 2} ) / ( ( {[ {E}^{2} + {R}^{2} ]}^{1 / 2} - E ) * ( L + E + {[ {( L + E )}^{2} + {R}^{2} ]}^{1 / 2} ) ) ) \} ) \qquad EQUATION 1$$

These formulae assume no internal reflection. Within the length of the bulb (z=0 to z=L), the dosage, CD_{L}, involves only W, L, and F, with no explicit dependence upon K or R (integrals involving R cancel). While this result is somewhat counter-intuitive, it can be understood by the linear velocity of K as F/K, such that, for example, when K is doubled, the linear velocity of K is halved so the dosage remains the same. When B and E are zero, CD_{B} and CD_{E} are also zero, respectively.

TABLE A
Illustrative Cumulative UVGI Dosage (CD) Formula Results*

| | UV-C Bulb Rating (Watts): | | | | | |
|---|---|---|---|---|---|---|
| | 18 W | | 36 W | | 60 W HO | |
| Number of Bulbs: | 1 | | 1 | | 1 | |
| UV-C Output: % | 30.8% | | 30.8% | | 40.0% | |
| UV-C Watts, W | 5.5 | | 11.1 | | 24.0 | |
| Envelope Length, L (Inches): | 7.5 | | 15.0 | | 15.0 | |
| Helix/Pipe Parameters: | | | | | | |
| Length, B + L + E (Inches): | 10.0 | | 17.5 | | 17.5 | |
| Distance before Bulb, B (Inches): | 1.25 | | 1.25 | | 1.25 | |
| Distance after Bulb, E (Inches): | 1.25 | | 1.25 | | 1.25 | |
| Helix Radius (I.D., Inches): | 3.0 | | 3.0 | | 3.0 | |
| Tubing Diameter (I.D., Inches): | 0.3937 | | 0.3937 | | 0.3937 | |
| Average Optical Path Length, P (cm) | 0.7820 | | 0.7820 | | 0.7820 | |
| Equivalent-Flow Pipe Radius, R (In.): | 1.3074 | | 1.3074 | | 1.3074 | |
| Water Flow Rate⁽¹⁾, F (US gpm): | 2.0 | 4.0 | 2.0 | 4.0 | 2.0 | 4.0 |
| Coefficient of Extinction⁽²⁾, ε (cm⁻¹) | 0.2 | | 0.2 | | 0.2 | |
| UVGI Dosage, CD (μwatt-sec/cm²): | | | | | | |
| CD_{B} + CD_{E} | 14,058 | 7,030 | 14,990 | 7,496 | 32,446 | 16,224 |
| CD_{L} | 837,002 | 418,501 | 3,348,007 | 1,674,003 | 7,246,768 | 3,623,384 |
| Photocatalytic Unit (CDₒ): | 851,060 | 425,530 | 3,362,997 | 1,681,498 | 7,279,214 | 3,639,607 |
| Adjusted for B-L Law⁽³⁾ (CD) | 727,463 | 363,731 | 2,874,597 | 1,437,298 | 6,222,071 | 3,111,036 |

*Note:
⁽¹⁾1.0 gpm (US liquid) = 0.133680556 cfm.
⁽²⁾The coefficient of extinction, ε, for 253.7 nm UV light in pure water is 0.007 cm⁻¹, in tap water it is 0.1 cm⁻¹, and in average US waste-water treatment plant discharge water it is 0.3 cm⁻¹ (References 7 and 8).
⁽³⁾CD = CDₒe^{-εP}

The results in TABLE A are self-consistent to the extent that doubling the water flow rate halves the UV dosage. Furthermore, a longer UV bulb extends the residency time in the irradiation field of the UV light source and, hence, the greater UV dosage calculated for one long 36 W bulb and one long 60 W high output bulb compared with one short 18 W bulb. Similarly, the corresponding results for the 36 W bulb are about four times that of the 18 W bulb at twice the power and twice the length. These results also imply consistent units conversions (imperial units to metric units and vice versa). The dosage units are W-sec/cm² (or J/cm²), which must be multiplied by 1,000,000 to convert to the usual “micro” units μW-sec/cm² or μJ/cm², as commonly used in the literature. Ninety percent (90% or “one log”) of many water-borne species of molds, bacteria, and viruses are killed or “deactivated” at dosages well under 100,000 μW-sec/cm².

The massive dosages, indicated by TABLE A, virtually assure the destruction of any biological pathogens, even (a) without the additional benefit of photocatalysis that also destroys microbes and contaminating compounds not perturbed by germicidal irradiation, (b) after attenuation of the UV intensity due to Beer-Lambert law adsorption, and (c) after shadowing by the “front side” photocatalyst coating.

### Photocatalyst Surface Area and Coating Density

The photocatalyst-coatable tubing coil interior surface area, A, is given by the tubing inside circumference times the length, L:

$$A = 2 π r \times L {cm}^{2} = π D \times L {cm}^{2} , \\ where \\ D = 2 r is the inside tubing diameter in cm . \qquad EQUATION 2$$

For a helix of N=32 turns of 0.5 inch I.D. tubing, where D is 6.0 inches, L˜=N×πD. Therefore, A˜=N*(πD)²=11,370 in.² or 73,353 cm².

For a tubing coil (helix) weighing S_{W} when freshly coated with wet sol gel solution of known concentration C and density ρ (e.g., g/ml of anatase TiO₂) and weighing S_{D} after drying (before baking), the weight of retained dry photocatalyst coating, PC, may be calculated as:

$$PC = ( {S}_{W} - {S}_{D} ) * C / ρ grams , \\ or = C * v , where v ( ml ) is the volume of sol gel retained by the tubing coil and the coating density per unit area of substrate surface is Coating Density = PC / A , g \text{/} {cm}^{2} . \qquad EQUATION 3$$

### Photocatalyst Coating Thickness and Effective Area

If the tubing coil of the above example retained 80 ml of 0.85% titanium dioxide sol gel also containing peroxotitanic acid binder with a combined solution density of 1.013 g/ml (0.0086 g/ml anatase sol gel and 0.0040 g/ml peroxotitanic acid binder that converts to anatase on baking). The retained sol gel weight implies approximately 1.04 g of TiO₂ (formula weight of 79.87 amu or g/mol) or 1.30×10⁻² mols. Therefore, the formula weight units (mols) per square centimeter are 1.30×10⁻²/73, 353=1.77×10⁻⁵ mols/cm². The unit cell dimensions of nanocrystalline anatase (see Weirich, Reference 9) are 3.872×3.872×9.616 cubic angstroms=0.14417 cubic nm or 0.03604 nm³ per TiO₂ unit (four TiO₂ units per anatase unit cell). Therefore, a densely packed “spherical” 10 nm diameter particle would contain approximately 14,528 TiO₂ formula units. Furthermore, given the Avogadro Number of formula units per mol (i.e., 6.022045×10²³), the number of mols/cm² implies 1.77×10⁻⁵×6.022045×10²³/14,528=7.34×10¹⁴ of 10 nm particles/cm². Assuming hexagonal closest packing of spheres, a single layer of 10 nm particles would have an areal packing density of approximately 12×0.5×5×10 nm²=300 nm² per 3 particles or 100 nm² per each 10 nm diameter particle. Each square cm of tubing surface would then accommodate 1/(100×10⁻¹⁴ cm² per particle) particles in a single layer or 1×10¹² particles per cm². This is less than the above calculated 7.34×10¹⁴ particles/cm² applied. This result implies a complete surface coating with no gaps between 10 nm particles or an average “mono-layer” particle size of more than 10 nm diameter. The greater apparent coverage than calculated for surface density of “compact” 10 nm particles suggests a higher degree of agglomeration.

A mono-layer of three-dimensional close-packed spheres (of uniform diameter) on a two-dimensional planar surface would have a total sphere surface area to plane surface area ratio of 2π/√3=2.094, independent of sphere diameter. Therefore, an estimate of photocatalyst area on a uniformly covered (no gaps) substrate surface is 2.094 times the substrate surface area. In the above tubing example, this implies a photocatalyst surface area of approximately 2.094×70.5×10³=148×10³ cm² per gram of photocatalyst, further enhanced by the distribution of photocatalyst particle sizes and surface roughness. While not all of this photocatalyst surface is accessible to UV photons, errors of over-estimation and under-estimation are expected to approximately cancel each other.

While the foregoing may emphasize the preferred embodiments of the present invention, for illustrative purposes, other and further embodiments may be devised without limiting or departing from the spirit and scope of the present invention, as determined by the following claims.

1. A photocatalytic water purification system and method comprising pre-filtration, an outer enclosure, a linear ultraviolet or near ultraviolet (UV, 100 to 450 nm wavelength range) light source (photocatalyst-activating), a water inlet port and a water outlet port, a water motive means (gravity, line pressure, or pump and motor), and a UV-transparent, internally photocatalyst-coated, tubing coil (helix) located concentrically about the longitudinal axis of the UV light source (the photocatalytic unit) such that both the water flowing through the coil as well as the photocataiyst coating within the coil are irradiated.

2. The source of photocatalyst-activating UV irradiation of claim 1 may be any linear UV generating lamp or columnar array of light emitting diodes (LEDs), but in the preferred embodiment is germicidal.

3. The outer housing of claim 1 may consist of any UV-resistant material but the internal surface would be UV light reflective, in all preferred embodiments.

4. The photocatalyst coating of claim 1 is any such material but, in a preferred embodiment, is a microcrystalline anatase titanium dioxide-based coating firmly bound to the interior surface of the tubing coil (helix) so as to be resistant to water-flow erosion.

5. The photocatalyst coating of claim 1 renders the internal surface of the tubing coil (helix) self-cleaning, under UV irradiation.

6. The tubing coil (helix) material of claim 1 is any material transparent to the UV radiation supplied but, in its preferred embodiment, is of high purity quartz, transparent to ultraviolet germicidal irradiation.

7. The tubing coil (helix) of claim 1 is tightly wound but of a diameter greater than that of the UV light source and of a length greater than or equal to that of the light source so as to maximize both (a) the transit time of the water in the radiation field of the UV light source, and (b) the irradiated-photocatalyst surface area to which the water in the tubing coil is exposed.

8. The coaxial geometry of the invention of claim 1 permits scaling of unit dimensions to accommodate a wide range of configurations, UV sources, tubing diameters and lengths, helix diameters and lengths, pumps, motors, filters, and power supplies, all engineered to application circumstances.

9. The photocatalytic coating on the interior surface of the helix of claims 1 and 5 may be applied by any technique, including (a) flushing the helix with an appropriate sol gel solution, (b) drying, and then (c) baking the coated helix (preferably between 250 and 940 degrees Celsius) to securely fix the coating and convert any intermediate titanium oxides to the anatase crystal form.

10. The helical geometry of the tubing coil of claim 1 ensures turbulent flow of the water stream and, therefore, intimate contact between the water-borne contaminants and the irradiated photocatalyst surface.

11. The transparent material of the tubing coil (helix) of claim 1 provides optical UV light transmission through and conduction throughout (reflection and refraction) the interior of the tubing material, thereby irradiatively contacting both sides of the photocatalytic coating.

12. The diameter of the tubing in the coil (helix) of claim 1 provides an upper limit to the optical path length of the of the UV radiation.

13. Any number of photocatalytic units of claim 1, consisting of the reflective enclosure, tubing coil, and UV light source may be combined in series or in parallel, to treat a given stream of water, although a parallel configuration increases the ultraviolet germicidal irradiation dosage due to the reduced water flow rates through the individual parallel units.

14. Direction of water flow through the tubing coil (helix) of claim 1 is not material, but filling of the helix against gravity (bottom up) assures that the helix is fully charged with water at lower flow rates, especially if any air or gas is comingled with the water.

15. Performance of the helix-based water purification system of claim 1 can be further enhanced by entrainment of air, oxygen, hydrogen peroxide, or ozone in the water stream. Additional oxygen species increase the concentration of photocatalyst-produced free radicals and positive “holes” at the photocatalyst surface that promote the oxidation and reduction reactions that destroy contaminant organic compounds and deactivate or destroy pathogenic microbes not removed by filtration.

16. The water purification system of claims 1 to 13 may be incorporated in fixed, portable, or mobile installations for residential, commercial, institutional, or industrial water treatment applications.

17. A formula (EQUATION 1) for estimating the average ultraviolet germicidal irradiation dosage delivered by a germicidal UV light source to the water stream within the tubing coil (helix) of claims 1 and 5.

18. Formulae for estimating (a) the available photocatalyst substrate surface (helix) area of claim 1 (EQUATION 2), and (b) the photocatalyst coating coverage density within the tubing coil (helix) of claims 1 and 5 (EQUATION 3).
